(19) United States
(12) Patent Application Publication
(10) Pub. No.: US 2026/0312393 A1
(43) Pub. Date: Oct. 8, 2026

(54) WIRING HARNESS

(71) Applicant: Sumitomo Wiring Systems, Ltd., Yokkaichi-shi (JP)

(72) Inventors: Takashi KAMBE, Yokkaichi-shi (JP); Go UENO, Yokkaichi-shi (JP); Miyu MIZUTANI, Yokkaichi-shi (JP); Mitsuhiro SHIMAMURA, Yokkaichi-shi (JP)

(73) Assignee: Sumitomo Wiring Systems, Ltd., Yokkaichi-shi (JP)

(21) Appl. No.: 19/639,572

(22) Filed: Apr. 6, 2026

(30) Foreign Application Priority Data
Apr. 4, 2025 (JP) 2025-062501

(51) Int. Cl. H02G 11/00; B60R 16/02

(52) U.S. Cl. CPC H02G 11/00; B60R 16/0207

(57) ABSTRACT

A wiring harness including: a wire group that is configured to be routed from a vehicle body to a sliding door that is openable and closeable with respect to the vehicle body; and a plurality of separate carriers that cover the wire group with the separate carriers rotatably coupled to each other and arranged adjacently along a coupling axis parallel to a direction in which the wire group extends.

### BACKGROUND

The present disclosure relates to a wiring harness.

Conventionally, wiring harnesses are provided with a wire group that is routed from a vehicle body to a sliding door that is openable and closeable with respect to the vehicle body, and a plurality of separate carriers that cover the wire group (e.g., see JP 2021-145512A). The separate carriers are rotatably coupled to each other and arranged adjacently along a coupling axis parallel to the direction in which the wire group extends, thereby allowing the wire group to bend while protecting the wire group.

These separate carriers each have a pair of side walls, a rotating shaft part provided in a vicinity of a first end portion of the pair of side walls, and a rotated shaft part provided in a vicinity of a second end portion of the pair of side walls. The rotating shaft part of the separate carrier fits rotatably into the rotated shaft part of an adjacent separate carrier.

### SUMMARY

Incidentally, with a wiring harness such as described above, there are cases where, for example, it is desired to change the rotatable angle of the separate carriers in part of the wiring harness to prevent the wiring harness from hitting against the vehicle body. In such cases, it is conceivable to change the rotatable angle of the separate carriers by changing the shape of the region where adjacent separator carriers engage, such as the shape of the pair of side walls, for example. However, in this case, there is a problem in that manufacturability is adversely affected, since multiple types of large components including the pair of side walls need to be manufactured. Specifically, for example, given that multiple types of large molds are required in order to mold the large components, cost increases.

An exemplary aspect of the disclosure provides a wiring harness capable of improving manufacturability.

A wiring harness of the present disclosure is a wiring harness including a wire group routed from a vehicle body to a sliding door openable and closeable with respect to the vehicle body, and a plurality of separate carriers covering the wire group and rotatably coupled to each other and arranged adjacently along a coupling axis parallel to a direction in which the wire group extends, the separate carriers each including a pair of side walls, a rotating shaft part provided in the pair of side walls in a vicinity of a first end portion thereof along the coupling axis, and a rotated shaft part provided in the pair of side walls in a vicinity of a second end portion thereof along the coupling axis and couplable to the rotating shaft part by the rotating shaft part fitting therein, the rotating shaft part having, in an outer peripheral portion thereof in a circumferential direction, a cutout portion that determines a rotatable angle of the separate carrier, the rotated shaft part having, in a portion thereof in the circumferential direction, a rotation regulating part disposed on an inner side of the cutout portion, and the rotating shaft part being formed separately from the pair of side walls and fixed to the pair of side walls.

According to the wiring harness of the present disclosure, manufacturability can be improved.

### BRIEF DESCRIPTION OF THE DRAWINGS

FIG. 1 is a schematic diagram from above showing part of a vehicle in which a sliding door is fully closed in one embodiment;

FIG. 2 is a schematic diagram from above showing part of the vehicle during operation of the sliding door in one embodiment;

FIG. 3 is a schematic diagram from above showing part of the vehicle in which the sliding door is fully open in one embodiment;

FIG. 4 is a partially exploded perspective view of a wiring harness in one embodiment;

FIG. 5 is an exploded perspective view of the separate carrier in one embodiment.

FIG. 6 is a perspective view of the separate carrier in one embodiment.

FIG. 7 is a plan view for describing the types of separate carriers in one embodiment; and

FIG. 8 is a plan view for describing the types of separate carriers in one embodiment.

### EMBODIMENTS OF THE DISCLOSURE

### Description of Embodiments of the Disclosure

Initially, modes of the present disclosure will be enumerated and described.

[1] A wiring harness of the present disclosure is a wiring harness including a wire group routed from a vehicle body to a sliding door openable and closeable with respect to the vehicle body, and a plurality of separate carriers covering the wire group and rotatably coupled to each other and arranged adjacently along a coupling axis parallel to a direction in which the wire group extends, the separate carriers each including a pair of side walls, a rotating shaft part provided in the pair of side walls in a vicinity of a first end portion thereof along the coupling axis, and a rotated shaft part provided in the pair of side walls in a vicinity of a second end portion thereof along the coupling axis and couplable to the rotating shaft part by the rotating shaft part fitting therein, the rotating shaft part having, in an outer peripheral portion thereof in a circumferential direction, a cutout portion that determines a rotatable angle of the separate carrier, the rotated shaft part having, in a portion thereof in the circumferential direction, a rotation regulating part disposed on an inner side of the cutout portion, and the rotating shaft part being formed separately from the pair of side walls and fixed to the pair of side walls.

According to this configuration, the rotating shaft part having the cutout portion that determines the rotatable angle of the separate carrier is formed separately from the pair of side walls and fixed to the pair of side walls, and thus, for example, the rotatable angle of the separate carrier can be changed simply by changing the rotating shaft part. That is, for example, the rotatable angle of the separate carrier can be changed, simply by changing the rotating shaft part, which is a small component, while making large components including the pair of side walls as common components. The need to manufacture multiple types of large components is thereby eliminated, for example, and manufacturability is improved. Specifically, for example, given factors such as no longer needing to prepare multiple types of large molds for molding large components, cost reductions can be achieved.

[2] In [1] above, the pair of side walls may have a fixing recessed part, the rotating shaft part may have a fixing part that fits into the fixing recessed part, and the fixing part may protrude radially outward beyond an outer peripheral surface of the rotating shaft part.

According to this configuration, the rotating shaft part has the fixing part that fits into the fixing recessed part of the pair of side walls, and the fixing part protrudes radially outward beyond the outer peripheral surface of the rotating shaft part, thus enabling the rotating shaft part to be securely fixed to the pair of side walls. That is, for example, with a configuration in which the fixing part does not protrude radially outward beyond the outer peripheral surface of the rotating shaft part, there is a possibility that the rotating shaft part will be damaged such as being twisted off, in cases such as when subjected to a force that stops the rotation of the separate carrier, but this can be suppressed.

[3] In [1] or [2] above, the rotating shaft may include a front-side rotating shaft part and a back-side rotating shaft part respectively provided on the side walls, and the front-side rotating shaft part and the back-side rotating shaft part may be respectively fixed to the side walls by different fixing structures.

According to this configuration, the rotating shaft includes the front-side rotating shaft part and the back-side rotating shaft part respectively provided on the side walls, and the front-side rotating shaft part and the back-side rotating shaft part are respectively fixed to the side walls by different fixing structures, thus preventing misassembly. For example, if the fixing structures of the front-side rotating shaft part and the back-side rotating shaft part are exactly the same, the angles of the two cutout portions could possibly be shifted due to the front-side rotating shaft part being fixed to both of the side walls, but this can be prevented.

[4] In any one of [1] to [3] above, the rotation regulating part may be provided in a region on the first end portion side in the rotated shaft part.

According to this configuration, the rotation regulating part is provided in a region on the first end portion side in the rotated shaft part and is thus unlikely to be damaged. For example, when the rotation regulating part is provided in a region on the second end portion side in the rotated shaft part, the rotation regulating part is easily damaged due to being connected in a readily deformable region of the pair of side walls between the rotated shaft part and the second end portion. In contrast, the rotation regulating part is connected to a central portion of the pair of side walls that is not readily deformable and is thus unlikely to be damaged.

[5] In [4] above, the pair of side walls may have, between the rotated shaft part and the second end portion, a thin part that is thinner than other regions thereof.

According to this configuration, the pair of side walls have a thin part that is thinner than other regions thereof between the rotated shaft part and the second end portion, and thus the rotating shaft part is readily fitted into the rotated shaft part, for example. Also, with this configuration, the region between the rotated shaft part and the second end portion is more likely to deform, compared to a configuration without the thin part, but the rotation regulating part is provided in a region on the first end portion side in the rotated shaft part, and thus is not easily damaged. That is, in a configuration having the thin part, the effect obtained by providing the rotation regulating part in a region on the first end portion side in the rotated shaft part is even greater.

### Detailed Description of Embodiments of the Disclosure

Specific examples of a wiring harness of the present disclosure will be described below with reference to the drawings. In the diagrams, part of the configuration may be shown in an exaggerated or simplified manner for convenience of description. Also, the dimensional ratios of various portions may differ in the diagrams.

The term “orthogonal” herein includes not only strictly orthogonal but also generally orthogonal within a range that achieves the operation and effect of the present embodiment.

The term “tubular” used herein includes not only members whose peripheral wall is formed continuously around the entire circumference thereof, but also members that combine a plurality of components to form a tubular shape, and members that have a cutout or the like in part thereof in the circumferential direction such as a C-shape. A “tubular” outer peripheral shape includes, but is not limited to, circular and oval shapes and polygonal shapes with pointed or rounded corners. The term “tubular” refers to a shape having a through hole in plan view, and includes members whose outer peripheral shape is the same as the inner circumference shape of the through hole, and members whose outer peripheral shape is different from the inner circumference shape of the through hole. The term “tubular” includes members having a predetermined length extending in an axial direction in which a central axis thereof that passes through the center of the through hole extends, regardless of the relative lengths of the members.

The term “opposing” herein means that surfaces or members are positioned in front of each other, and includes not only the case where the portions are perfectly in front of each other but also the case where the portions are partially in front of each other. Also, “opposing” herein includes both the case where there is another member interposed between the two portions, and the case where there is no other member interposed between the two portions.

Terms such as “first” and “second” herein are used simply to distinguish between objects and do not rank the objects. The present disclosure is not limited to these illustrative examples and is indicated by the claims, and all changes that come within the meaning and range of equivalency of the claims are intended to be embraced therein.

### Configuration of Wire Harness 20

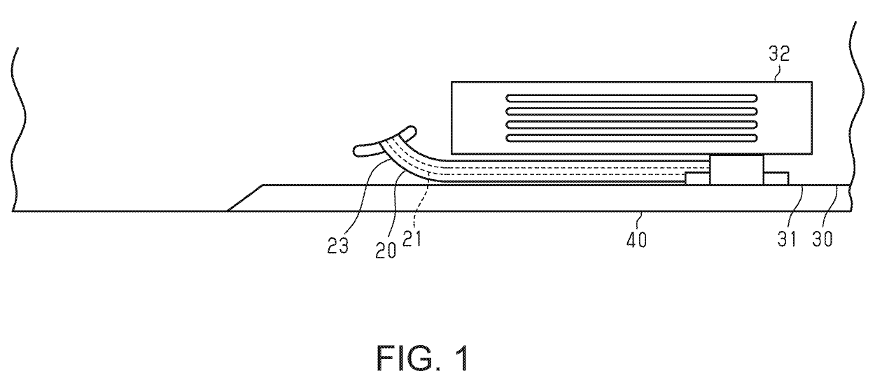

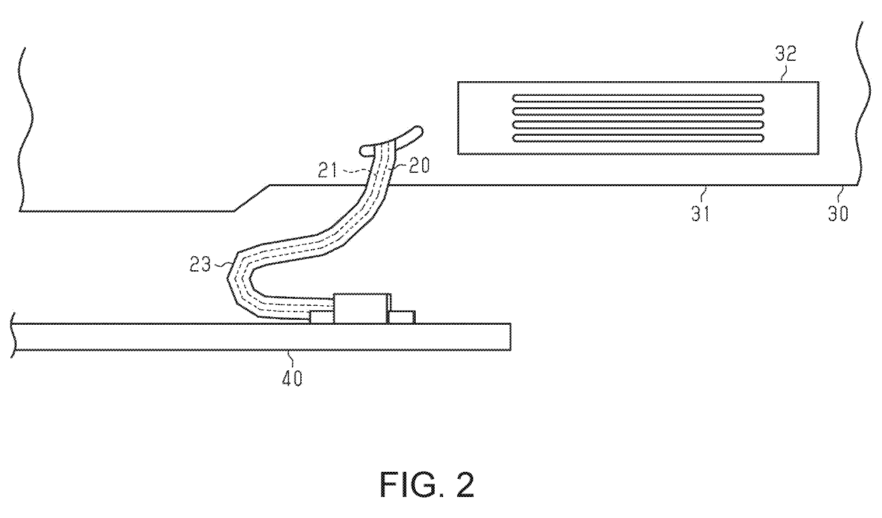

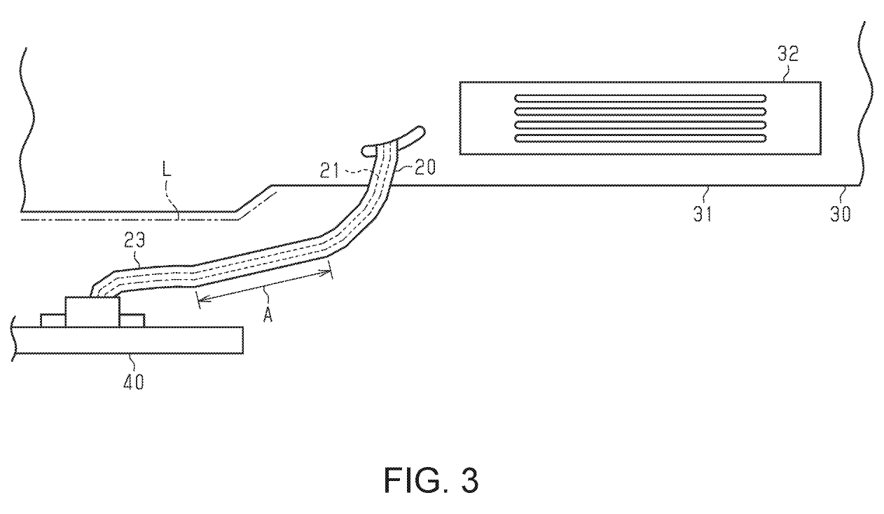

As shown in FIGS. 1 to 3, a wiring harness 20 is provided with a wire group 21 that is routed from a vehicle body 30 to a sliding door 40 of a vehicle. The wire group 21 electrically connects a power control device (not shown) provided in the vehicle body 30 to electrical devices (not shown) provided in the sliding door 40. Note that the electrical devices are, for example, a power window motor, a lock actuator, and the like, and the power control device is a device for supplying power to those electrical devices. The vehicle body 30 has an opening 31 that is openable and closeable by the sliding door 40. Also, the vehicle body 30 is provided with a running board 32. The running board 32 is provided in a region corresponding to the sliding door 40 on the vehicle inner side (upper side in FIG. 1) with respect to an edge portion of the vehicle outer side (lower side in FIG. 1) of the opening 31. The running board 32 is where users place their feet when getting in and out of the vehicle. Also, the sliding door 40 is provided in a manner slidable in a front-back direction (right-left direction in FIG. 1) of the vehicle body 30 by a mechanism (not shown). Specifically, the sliding door 40 is movable to the vehicle outer side (lower side in FIG. 1) of the vehicle body 30 from a fully closed state (see FIG. 1) while being slid in a rearward direction (leftward direction in FIG. 2) of the vehicle body 30 to a fully open state (FIG. 3) by the mechanism (not shown).

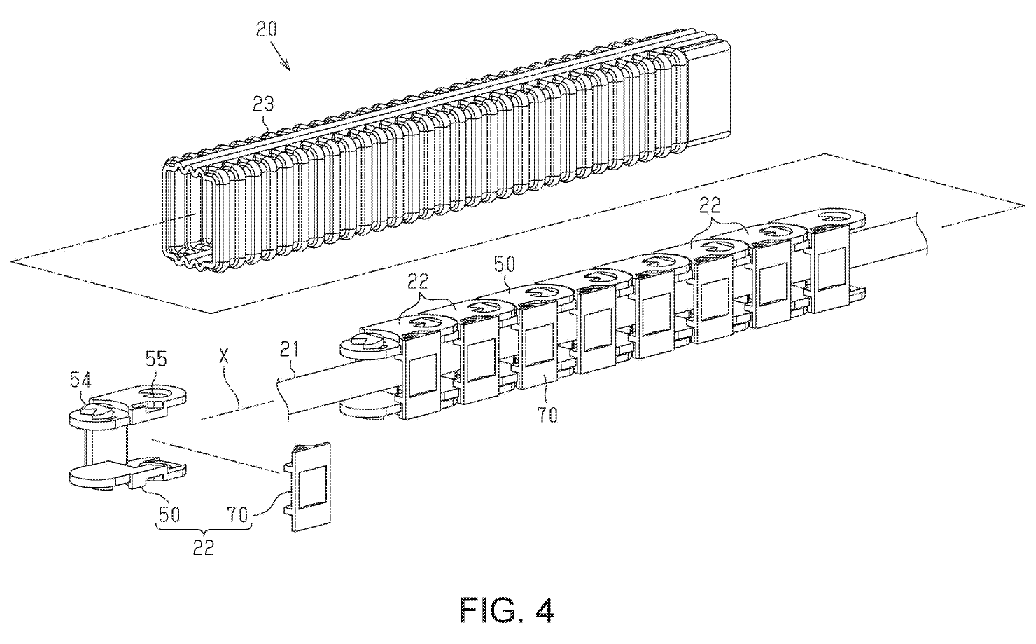

As shown in FIG. 4, the wiring harness 20 is provided with the wire group 21, the separate carriers 22, and a rubber boot 23. Note that FIG. 4 shows part of the wiring harness 20 with one separate carrier 22 and the rubber boot 23 in an exploded state. Also, the wire group 21 is constituted by a plurality of wires bundled together but is shown schematically in the diagram and illustration of the individual wires is omitted.

### Configuration of Separate Carriers 22

The separate carriers 22 are made of a resin material.

The separate carriers 22 cover the wire group 21 and are rotatably coupled to each other and arranged adjacently along a coupling axis X that is parallel to the direction in which the wire group 21 extends. Note that the coupling axis X referred to here is an axis along the wire group 21 extended in a straight state.

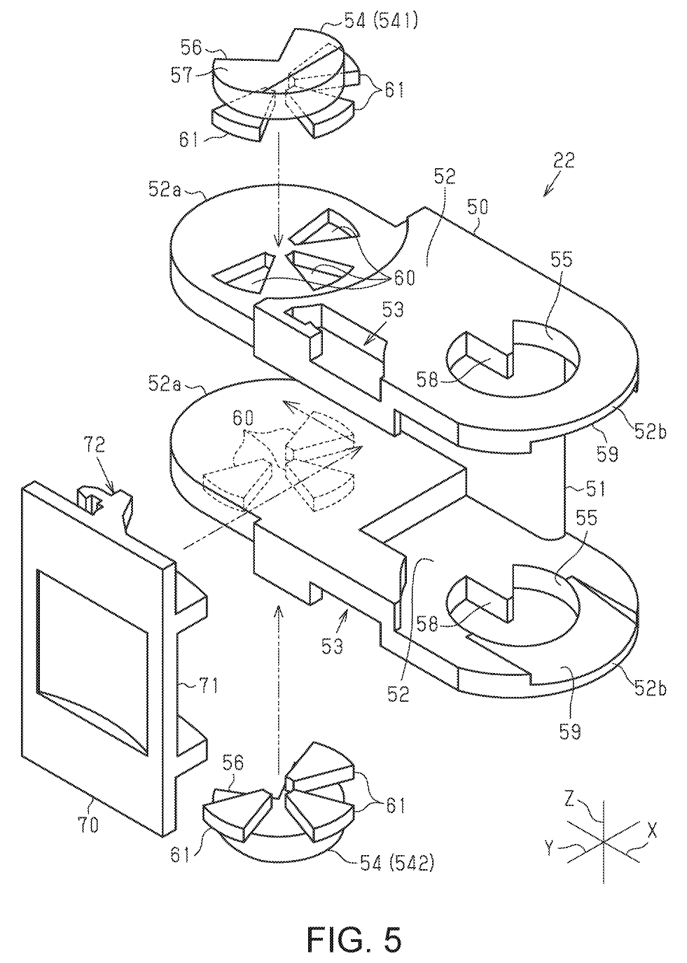

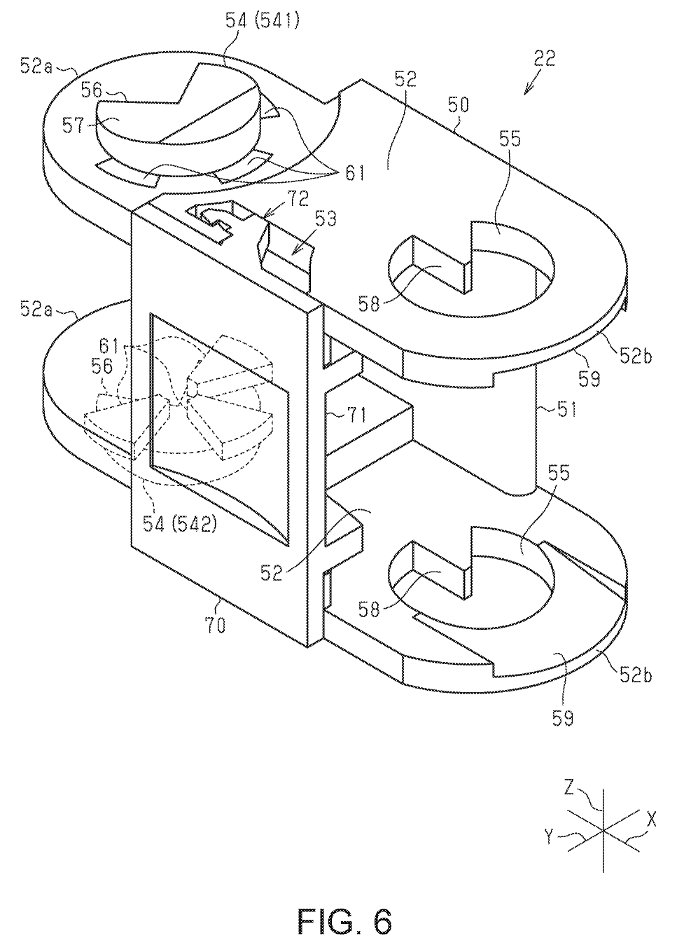

As shown in FIGS. 5 and 6, the separate carriers 22 each have a separate carrier body 50 and a carrier cover 70. Note that the diagrams show the coupling axis X, a coupling intersecting axis Y that intersects the coupling axis X and is orthogonal to the coupling axis X, and a parallel arrangement axis Z that is orthogonal to the coupling axis X and the coupling intersecting axis Y.

The separate carrier body 50 is formed in a U-shape that is open along the coupling intersecting axis Y due to having a back wall 51 and a pair of side walls 52 that extend from both ends of the back wall 51. In other words, the separate carrier body 50 is formed in a U-shape when viewed along the coupling axis X.

Also, the carrier cover 70 has a plate-shaped part 71 that blocks the opening of the U-shaped separate carrier body 50 when fixed to the separate carrier body 50. That is, the carrier cover 70 has the plate-shaped part 71 disposed so as to join the distal ends of the side walls 52.

The separate carrier body 50 has an engaged part 53 on each of the side walls 52. The carrier cover 70 has an engaging part 72 that is fixed by being slid along the coupling axis X with respect to the engaged part 53.

Specifically, the engaging part 72 is locked onto the engaged part 53 due to the carrier cover 70 first being moved along the coupling intersecting axis Y and, thereafter, being slid along the coupling axis X with respect to the separate carrier body 50, thereby fixing the carrier cover 70 to the separate carrier body 50.

Also, the separate carrier body 50 has a rotating shaft part 54 (rotating shaft) and a rotated shaft part 55 (rotated shaft hole). The rotating shaft part 54 is provided in the pair of side walls 52 in a vicinity of a first end portion 52a thereof along the coupling axis X. The rotated shaft part 55 is provided in the pair of side walls 52 in a vicinity of a second end portion 52b thereof along the coupling axis X. The rotated shaft part 55 is couplable to the rotating shaft part 54 of another separate carrier 22 adjacent thereto, by the rotating shaft part 54 fitting therein.

The rotating shaft part 54 protrudes along the parallel arrangement axis Z from the outer surface of the pair of side walls 52. The rotating shaft part 54 is formed in a columnar shape and has a cutout portion 56 (cutout) for determining the rotatable angle of the separate carrier 22 in an outer peripheral portion thereof in the circumferential direction.

The cutout portion 56 of the present embodiment is cut out in a range of 90 degrees on the outer peripheral surface of the rotating shaft part 54. Also, the cutout portion 56 of the present embodiment is cut out linearly from an axial center of the rotating shaft part 54 to the outer periphery. Also, the cutout portion 56 of the present embodiment is cut out so as to open toward the first end portion 52a of the pair of side walls 52. Also, the rotating shaft part 54 of the present embodiment has a shaft inclined surface 57 whose height gradually decreases proceeding toward the first end portion 52a of the pair of side walls 52.

The rotated shaft part 55 is a hole that passes through the pair of side walls 52. The rotated shaft part 55 has a rotation regulating part 58 on a circumferential portion thereof. The rotation regulating part 58 is disposed on the inner side of the cutout portion 56 in an adjacent separate carrier 22.

The rotation regulating part 58 is provided in the rotated shaft part 55 in a region thereof nearest the first end portion 52a of the pair of side walls 52. That is, the rotation regulating part 58 protrudes toward the axial center of the rotated shaft part 55 from a region on the first end portion 52a side in the rotated shaft part 55. The rotation regulating part 58 of the present embodiment protrudes toward the axial center from a range of 45 degrees on the inner peripheral surface of the rotated shaft part 55.

Also, the pair of side walls 52 have a thin part 59 that is thinner than other regions thereof between the rotated shaft part 55 and the second end portion 52b. The thin part 59 is formed by a recessed portion provided in opposing surfaces of the pair of side walls 52. The thin part 59 is formed to gradually become thinner proceeding toward the second end portion 52b from the rotated shaft part 55.

Here, as shown in FIG. 5, the rotating shaft part 54 is formed separately from the pair of side walls 52 and fixed to the pair of side walls 52. Specifically, the pair of side walls 52 have a fixing recessed part 60 (fixing recess), and the rotating shaft part 54 has a fixing part 61 that fits into the fixing recessed part 60. The fixing part 61 protrudes radially outward beyond the outer periphery surface of the rotating shaft part 54. The fixing part 61 of the present embodiment is three fixing parts 61 that extend radially from the axial center of the rotating shaft part 54, and the three fixing parts 61 are each formed to protrude radially outward beyond the outer peripheral surface of the rotating shaft part 54. Also, three fixing recessed parts 60 are, of course, provided for the three fixing parts 61 to fit into. The fixing parts 61 of the present embodiment are then fitted into the fixing recessed parts 60 and fixed to the fixing recessed parts 60 by an adhesive.

Also, the rotating shaft part 54 includes a front-side rotating shaft part 541 and a back-side rotating shaft part 542 respectively provided on the side walls 52. The front-side rotating shaft part 541 and the back-side rotating shaft part 542 are respectively fixed to the side walls 52 by different fixing structures. The front-side rotating shaft part 541 and the back-side rotating shaft part 542 of the present embodiment have different fixing structures due to being formed such that the interval between the fixing parts 61 and the circumferential widths of the fixing parts 61 differ slightly. Note that, of course, the shapes of the fixing recessed parts 60 respectively provided in the side walls 52 also differ according to the fixing parts 61. A configuration is thereby adopted in which there is no possibility of, for example, the front-side rotating shaft part 541 being fixed to both of the side walls 52.

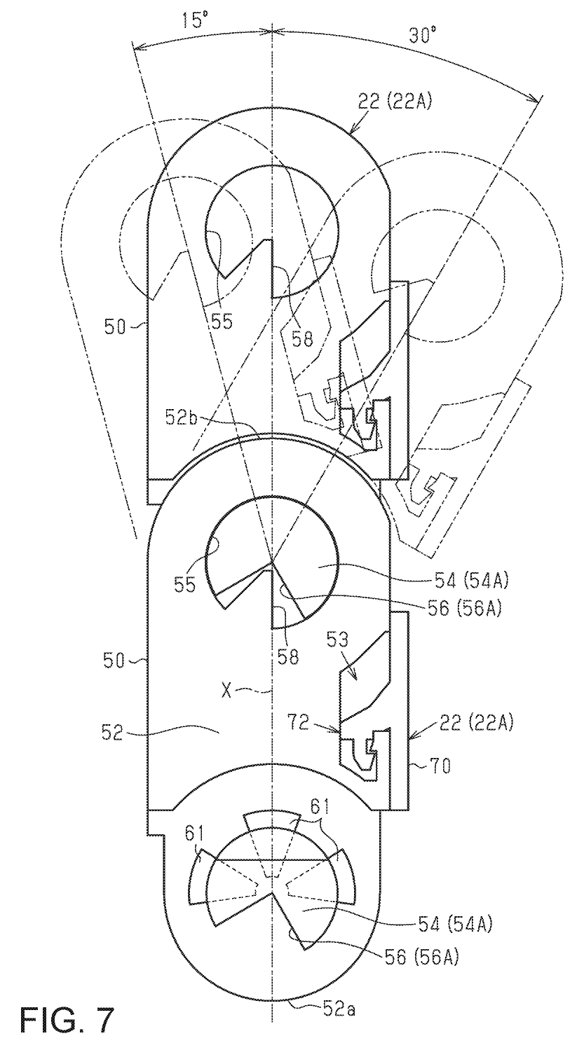

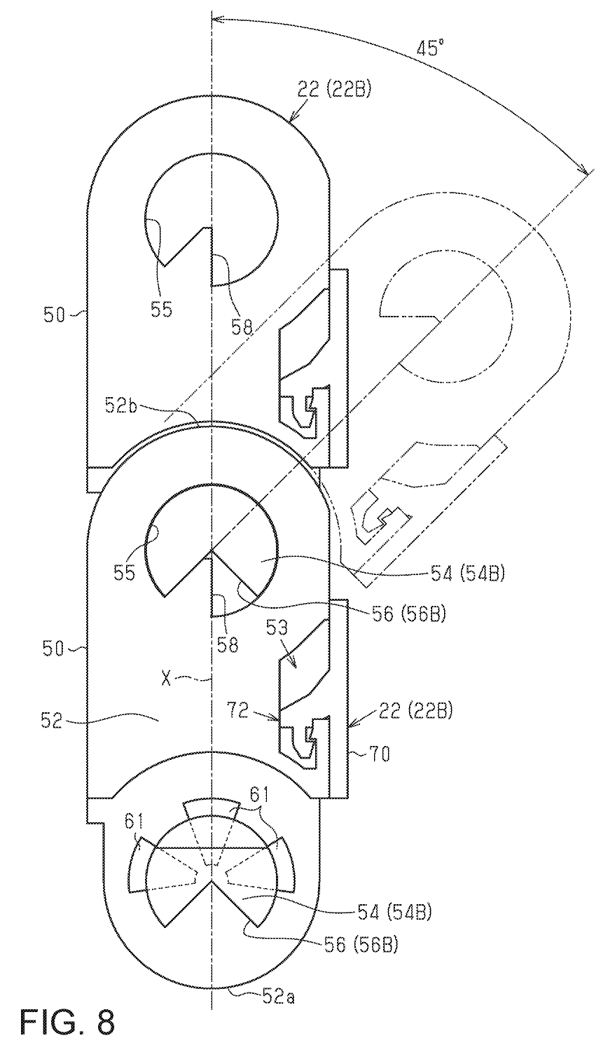

As shown in FIGS. 7 and 8, there are two types of separate carriers 22 provided in the wiring harness 20 of the present embodiment, namely, a first separate carrier 22A (see FIG. 7) and a second separate carrier 22B (see FIG. 8), with different rotatable angles. The first separate carrier 22A has a first rotating shaft part 54A (see FIG. 7), and the second separate carrier 22B has a second rotating shaft part 54B (see FIG. 8). A cutout portion 56A (see FIG. 7) in the first rotating shaft part 54A has a different shape from a cutout portion 56B (see FIG. 8) in the second rotating shaft part 54B. That is, the cutout portion 56A and the cutout portion 56B are set to different ranges with respect to the coupling axis X.

As shown in FIG. 7, the first separate carrier 22A is thereby rotatable 15 degrees counterclockwise, in the diagram, in a first rotation direction from a straight state, and is rotatable 30 degrees clockwise, in the diagram, in a second rotation direction from the straight state. Also, as shown in FIG. 8, the second separate carrier 22B is not rotatable counterclockwise, in the diagram, in the first rotation direction from a straight state, and is rotatable 45 degrees clockwise, in the diagram, in the second rotation direction from the straight state.

The first separate carriers 22A and the second separate carriers 22B constituting the separate carriers 22 are combined in such a manner as to ensure that the wiring harness 20 does not protrude to the vehicle body 30 side (upper side in FIG. 3) beyond a protrusion prevention line L (see FIG. 3). Note that the protrusion prevention line L is a line that is set for each vehicle model, such that a certain distance is maintained from the vehicle body 30 along the vehicle body 30, for example.

As shown in FIG. 3, for example, in the present embodiment, the second separate carrier 22B (see FIG. 8) is employed in an intermediate range A of the wiring harness 20. The wiring harness 20 is thereby prevented from protruding to the vehicle body 30 side (upper side in FIG. 3) beyond the protrusion prevention line L. Therefore, the wiring harness 20 is prevented from hitting against the vehicle body 30. Note that the first separate carrier 22A (see FIG. 7) is employed in ranges of the wiring harness 20 other than the intermediate range A. Also, the combination of the first separate carriers 22A and the second separate carriers 22B may, of course, be changed as appropriate according to the protrusion prevention line L set for each vehicle model and the like, for example.

### Configuration of Rubber Boot 23

The rubber boot 23 is made of a rubber material.

As shown in FIG. 4, the rubber boot 23 is provided so as to cover the separate carriers 22 coupled rotatably. The rubber boot 23 is formed in a tubular shape and has a bellows structure constituted by alternating recessed and raised portions in the extension direction. The rubber boot 23 is formed in a manner readily bendable due to the bellows structure and allows for rotation of the separate carriers 22.

### Operation of the Embodiment

Next, operation of the wiring harness 20 configured as described above will be described.

As shown in FIGS. 1 to 3, when the sliding door 40 is slid in the front-back direction of the vehicle body 30, the wiring harness 20 deforms. At this time, the wire group 21 deforms while being protected by the separate carriers 22 due to the separate carriers 22 mutually rotating. Also, the wiring harness 20 is prevented from protruding to the vehicle body 30 side beyond the protrusion prevention line L (see FIG. 3), due to the first separate carrier 22A (see FIG. 7) and the second separate carrier 22B (see FIG. 8) being employed as the separate carriers 22.

### Effect of the Embodiment

Next, the effect of the above embodiment will be described.
(1) The rotating shaft part 54 having the cutout portion 56 that determines the rotatable angle of the separate carrier 22 is formed separately from the pair of side walls 52 and fixed to the pair of side walls 52. Therefore, for example, the rotatable angle of the separate carrier 22 can be changed simply by changing the rotating shaft part 54. That is, for example, the rotatable angle of the separate carrier 22 can be changed, simply by changing the rotating shaft part 54, which is a small component, while constituting the separate carrier body 50, which is a large component, including the pair of side walls 52 as a common component. The need to manufacture multiple types of large components, for example, is thereby eliminated, and manufacturability is improved. Specifically, for example, given factors such as no longer needing to prepare multiple types of large molds for molding large components, cost reductions can be achieved.
(2) The rotating shaft part 54 has the fixing parts 61 that fit into the fixing recessed parts 60 of the pair of side walls 52, and the fixing parts 61 protrude radially outward beyond the outer peripheral surface of the rotating shaft part 54, thus enabling the rotating shaft part 54 to be securely fixed to the pair of side walls 52. That is, for example, with a configuration in which the fixing parts 61 do not protrude radially outward beyond the outer peripheral surface of the rotating shaft part 54, there is a possibility that the rotating shaft part 54 will be damaged such as being twisted off, in cases such as when subjected to a force that stops the rotation of the separate carrier 22, but this can be suppressed.
(3) The rotating shaft part 54 includes the front-side rotating shaft part 541 and the back-side rotating shaft part 542 respectively provided on the side walls 52, and the front-side rotating shaft part 541 and the back-side rotating shaft part 542 are respectively fixed to the side walls 52 by different fixing structures, thus preventing misassembly. For example, if the fixing structures of the front-side rotating shaft part 541 and the back-side rotating shaft part 542 are exactly the same structure, the angles of the two cutout portions 56 could possibly be shifted due to the front-side rotating shaft part 541 being fixed to both of the side walls 52, but this can be prevented.
(4) The rotation regulating part 58 is provided in a region on the first end portion 52a side in the rotated shaft part 55, and is thus unlikely to be damaged. For example, when the rotation regulating part 58 is provided in a region on the second end portion 52b side in the rotated shaft part 55, the rotation regulating part 58 is easily damaged due to being connected in a readily deformable region of the pair of side walls 52 between the rotated shaft part 55 and the second end portion 52b. In contrast, the rotation regulating part 58 is connected to a central portion of the pair of side walls 52 that is not readily deformable, and thus damage is unlikely.
(5) The pair of side walls 52 have the thin part 59 that is thinner than other regions thereof between the rotated shaft part 55 and the second end portion 52b, and thus the rotating shaft part 54 is more easily fitted into the rotated shaft part 55, for example. Also, with this configuration, the region between the rotated shaft part 55 and the second end portion 52b is more likely to deform, compared to a configuration that does not have the thin part 59, but the rotation regulating part 58 is provided in a region on the first end portion 52a side in the rotated shaft part 55, and is thus not easily damaged. That is, in a configuration having the thin part 59, the effect obtained by providing the rotation regulating part 58 in a region on the first end portion 52a side in the rotated shaft part 55 is even greater.

### Modifications

The above embodiment can be implemented in modified form as follows. The above embodiment and the following modifications can be implemented in combination to the extent that no technical inconsistencies arise.
In the above embodiment, the pair of side walls 52 have the fixing recessed parts 60, and the rotating shaft part 54 has the fixing parts 61 that fit into the fixing recessed parts 60, but the present disclosure is not limited thereto. For example, a configuration may be adopted in which the fixing recessed parts 60 and the fixing parts 61 that fit into the fixing recessed parts 60 are not provided, and the rotating shaft part 54 is fixed to the pair of side walls 52 by another fixing structure. Also, in the above embodiment, the fixing parts 61 are fitted into the fixing recessed parts 60 and fixed to the fixing recessed parts 60 by an adhesive, but the present disclosure is not limited thereto, and, for example, the fixing parts 61 may be fixed by being press fit into the fixing recessed parts 60.
In the above embodiment, the fixing parts 61 protrude radially outward beyond the outer peripheral surface of the rotating shaft part 54, but the present disclosure is not limited thereto. For example, a configuration may be adopted in which the fixing parts 61 do not protrude radially outward beyond the outer peripheral surface of the rotating shaft part 54.
In the above embodiment, the front-side rotating shaft part 541 and the back-side rotating shaft part 542 are respectively fixed to the side walls 52 by different fixing structures, but the present disclosure is not limited thereto. For example, the front-side rotating shaft part 541 and the back-side rotating shaft part 542 may be respectively fixed to the side walls 52 by the same fixing structure. That is, a configuration may be adopted in which, for example, the front-side rotating shaft part 541 is fixable to both of the side walls 52.
In the above embodiment, the rotation regulating part 58 is provided in a region on the first end portion 52a side in the rotated shaft part 55, but the present disclosure is not limited thereto, and, for example, the rotation regulating part 58 may be provided in a region on the second end portion 52b side in the rotated shaft part 55. That is, the rotation regulating part 58 may be connected to a region between the rotated shaft part 55 and the second end portion 52b in the pair of side walls 52.
In the above embodiment, the pair of side walls 52 have the thin part 59 that is thinner than other regions thereof between the rotated shaft part 55 and the second end portion 52b, but the present disclosure is not limited thereto, and a configuration may be adopted in which the thin part 59 is not provided.
In the above embodiment, the rotating shaft part 54 having the cutout portion 56 is provided on each of the side walls 52, but the present disclosure is not limited thereto, and the rotating shaft part 54 having the cutout portion 56 may be provided on only one of the side walls 52.
In the above embodiment, the rotated shaft part 55 is a hole that passes through the pair of side walls 52, but the rotated shaft part 55 may be changed to any shape with respect to which the rotating shaft part 54 fits rotatably, and may, for example, be a recessed part into which the rotating shaft part 54 but does not pass through.
In the above embodiment, the carrier cover 70 is fixed by first being move along the coupling intersecting axis Y and, thereafter, being slid along the coupling axis X with respect to the separate carrier body 50, but the present disclosure is not limited thereto, and other fixing structures may be employed.

For example, a configuration may be adopted in which the separate carrier body 50 has a locking claw that protrudes along the coupling intersecting axis Y, and the carrier cover 70 has a locking hole in which the locking claw is locked, and is fixed by being moved along the coupling intersecting axis Y with respect to the separate carrier body 50.
In the above embodiment, as the separate carriers 22 provided in the wiring harness 2, two types of separate carriers 22 with different rotatable angles, namely, the first separate carrier 22A and the second separate carrier 22B, are used, but the present disclosure is not limited thereto. For example, as the separate carriers 22 provided in the wiring harness 20, three or more types of separate carriers 22 with different rotatable angles may be used.
In the above embodiment, the wiring harness 20 is provided with the rubber boot 23, but the present disclosure is not limited thereto, and a configuration may be adopted in which the rubber boot 23 is not provided. That is, a configuration may be adopted in which the separate carriers 22 are exposed to the outside.
The embodiments disclosed herein are to be considered in all respects as illustrative examples, and the present disclosure is not limited to these illustrative examples. That is, the scope of the disclosure is indicated by the claims, and all changes that come within the meaning and range of equivalency of the claims are intended to be embraced therein.

What is claimed is:

1. A wiring harness comprising:
a wire group that is configured to be routed from a vehicle body to a sliding door that is openable and closeable with respect to the vehicle body; and
a plurality of separate carriers that cover the wire group with the separate carriers rotatably coupled to each other and arranged adjacently along a coupling axis parallel to a direction in which the wire group extends, wherein:
each separate carrier of the separate carriers includes:
a pair of side walls;
a rotating shaft provided in the pair of side walls at a first end of the pair of side walls along the coupling axis; and
a rotated shaft hole provided in the pair of side walls at a second end of the pair of side walls along the coupling axis and couplable to the rotating shaft by the rotating shaft fitting in the rotated shaft hole,
the rotating shaft has, in an outer peripheral portion thereof in a circumferential direction, a cutout that determines a rotatable angle of the separate carrier,
the rotated shaft hole has, in a portion thereof in the circumferential direction, a rotation regulating part disposed on an inner side of the cutout, and
the rotating shaft is formed separately from the pair of side walls and fixed to the pair of side walls.

2. The wiring harness according to claim 1, wherein:
the pair of side walls have a fixing recess,
the rotating shaft has a fixing part that fits into the fixing recess, and
the fixing part protrudes radially outward beyond an outer peripheral surface of the rotating shaft.

3. The wiring harness according to claim 1, wherein:
the rotating shaft includes a front-side rotating shaft part and a back-side rotating shaft part respectively provided on the pair of side walls, and
the front-side rotating shaft part and the back-side rotating shaft part are respectively fixed to the pair of side walls by different fixing structures.

4. The wiring harness according to claim 1,
wherein the rotation regulating part is provided in a region on a first end portion side in the rotated shaft hole.

5. The wiring harness according to claim 4,
wherein the pair of side walls have, between the rotated shaft hole and the second end, a thin part that is thinner than other regions thereof.
